(19) United States
(12) Patent Application Publication
(10) Pub. No.: US 2007/0101861 A1
(43) Pub. Date: May 10, 2007

(54) Two-speed cylinder

(76) Inventor: Danny Turner, Shippensburg, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/583,956

(22) Filed: Oct. 19, 2006

Related U.S. Application Data
(60) Provisional application No. 60/728,520, filed on Oct. 20, 2005.
(60) Provisional application No. 60/733,411, filed on Nov. 4, 2005.

(51) Int. Cl. F16J 10/00

(52) U.S. Cl. 92/169.1

(57) ABSTRACT

A two-speed cylinder of the invention comprises a cylinder tube having an open end and a closed end, with at least one cylinder port located in the tube. A bearing sleeve is movably mounted in the tube. The bearing sleeve comprises a body and a bearing sleeve head. The bearing sleeve body has at least one port. The cylinder also comprises a rod having a first end and a second end, with the second end of the rod configured to slidably engage the bearing sleeve when the bearing sleeve is inside the tube.

### CROSS REFERENCE TO RELATED APPLICATIONS

This application claims priority to U.S. Provisional Application No. 60/728,520 filed Oct. 20, 2005 and also U.S. Provisional Application No. 60/733,411 filed Nov. 4, 2005, both of which applications are herein incorporated by reference in their entirety.

### BACKGROUND OF THE INVENTION

1. Field of the Invention

This invention relates generally to cylinder assemblies and, in one particular embodiment, to a dual-acting hydraulic cylinder.

2. Technical Considerations

Fluid powered linear actuators are commonly referred to in the mechanical arts as “cylinders”. These known cylinders are generally either pneumatically or hydraulically actuated. One common type of cylinder is a conventional rod cylinder in which a cylindrical rod moves into and out of the cylinder casing or cylinder tube due to fluid pressure on the end of the rod. Another common type of cylinder is a piston cylinder. A piston cylinder is similar to a rod cylinder but the end of the rod has a larger surface area “piston” attached thereto to increase the surface area upon which the fluid pressure acts.

As will be appreciated by one of ordinary skill in the art, the force that a cylinder can exert on a load is based primarily on two factors. These are (1) the pressure of the fluid utilized in the cylinder and (2) the surface area across which the pressure is exerted. A rod cylinder utilizes the surface area of the end of the rod to do work. A piston cylinder utilizes the larger surface area of the piston to do work. If two cylinders of identical tube size, rod size (diameter and length), and fluid pressure are compared, the piston cylinder will be able to exert more force than the rod cylinder due to the fluid pressure acting over the larger surface area of the piston. However, given equal flow rates of the actuating fluid into the cylinders, the rod cylinder will travel more quickly than the piston cylinder. That is, the rod of the rod cylinder will extend more rapidly out of the tube than the rod of the piston cylinder.

One of the challenges of fluid power has been to get a piston cylinder to act as quickly as a rod cylinder when greater force is not needed. Two conventional ways to achieve this goal are: (1) to use a pump with variable volume displacement to increase fluid flow when high pressure (larger force) is not needed or (2) regenerating fluid from the rod side of the piston into the opposite side of the piston. Both of these methods have drawbacks. The use of variable displacement pumps increases the cost and size of the system. Regeneration requires the use of a complex combination of valves to divert the fluid from one side of the piston to the other or to a reservoir. Regeneration also typically requires higher fluid flow rates through the cylinder ports and associated piping.

Therefore, it would be advantageous to provide a cylinder that combines the operational characteristics of both a piston cylinder and a rod cylinder. That is, a cylinder that provides a large initial force (characteristic of a piston cylinder) to move a load followed by a lower force but faster speed (characteristic of a rod cylinder) once the load is in motion.

### SUMMARY OF THE INVENTION

A two-speed cylinder of the invention comprises a cylinder tube having an open end and a closed end, with at least one cylinder port located in the tube. A bearing sleeve is movably mounted in the tube. The bearing sleeve comprises a body and a bearing sleeve head. The bearing sleeve body has at least one port. The cylinder also comprises a rod having a first end and a second end, with the second end of the rod configured to slidably engage the bearing sleeve when the bearing sleeve is inside the tube.

A dual-acting cylinder of the invention comprises a cylinder tube having an open end and a closed end. The cylinder tube includes an extension port spaced from a retraction port. A bearing sleeve is movably mounted in the tube. A rod is provided having a first end and a second end, with the second end of the rod configured to slidably engage the bearing sleeve. The bearing sleeve comprises at least one sleeve port and at least one retraction port.

A cylinder of the invention comprises a cylinder tube having at least one cylinder port and a bearing sleeve movably carried on the cylinder tube. The bearing sleeve comprises a body portion and at least one sleeve port. A rod is provided having a first end and a second end, with the second end of the rod movably carried in the bearing sleeve.

### BRIEF DESCRIPTION OF THE DRAWINGS

Additional advantages and details of the invention are explained in greater detail below with reference to the exemplary embodiments illustrated in the accompanying schematic figures, in which like reference numbers identify like parts throughout.

FIG. 1a is a side view of a cylinder rod of the invention;

FIGS. 1b and 1c are a side view and a plan view of a bearing sleeve of the invention;

FIG. 1d is a side view of a cylinder tube of the invention;

FIG. 1e is a side view of a cylinder gland of the invention;

FIG. 1f is a side view of a gland cap of the invention;

FIGS. 1g and 1h are a side view and a plan view of a rod bearing of the invention;

FIGS. 2a and 2b are a side view and a plan view of a cylinder of the invention at 0% extension;

FIGS. 3a and 3b are a side view and a plan view of the cylinder of FIGS. 2a-b at 25% extension;

FIGS. 4a and 4b are a side view and a plan view of the cylinder of FIGS. 2a-b at 50% extension;

FIGS. 5a and 5b are a side view and a plan view of the cylinder of FIGS. 2a-b at 75% extension;

FIGS. 6a and 6b are a side view and a plan view of the cylinder of FIGS. 2a-b at 100% extension;

FIG. 7 is a side view of various components of a double-acting cylinder of the invention;

FIG. 8 is a side, sectional view of a double-acting cylinder of the invention in a retracted position;

FIG. 9 is a side, sectional view of the double-acting cylinder of FIG. 8 in an extended position;

FIGS. 10a-10d are side views of the components of another exemplary cylinder of the invention; and

FIGS. 11a-11f are side views of another exemplary cylinder of the invention.

### DESCRIPTION OF THE PREFERRED EMBODIMENTS

As used herein, spatial or directional terms, such as “up”, “down”, “above”, “below”, “top”, “bottom”, “left”, “right”, and the like, relate to the invention as it is shown in the drawing figures. However, it is to be understood that the invention can assume various alternative orientations and, accordingly, such terms are not to be considered as limiting.

The individual components of an exemplary embodiment of the invention will first be described and then operation of an exemplary cylinder of the invention will be described.

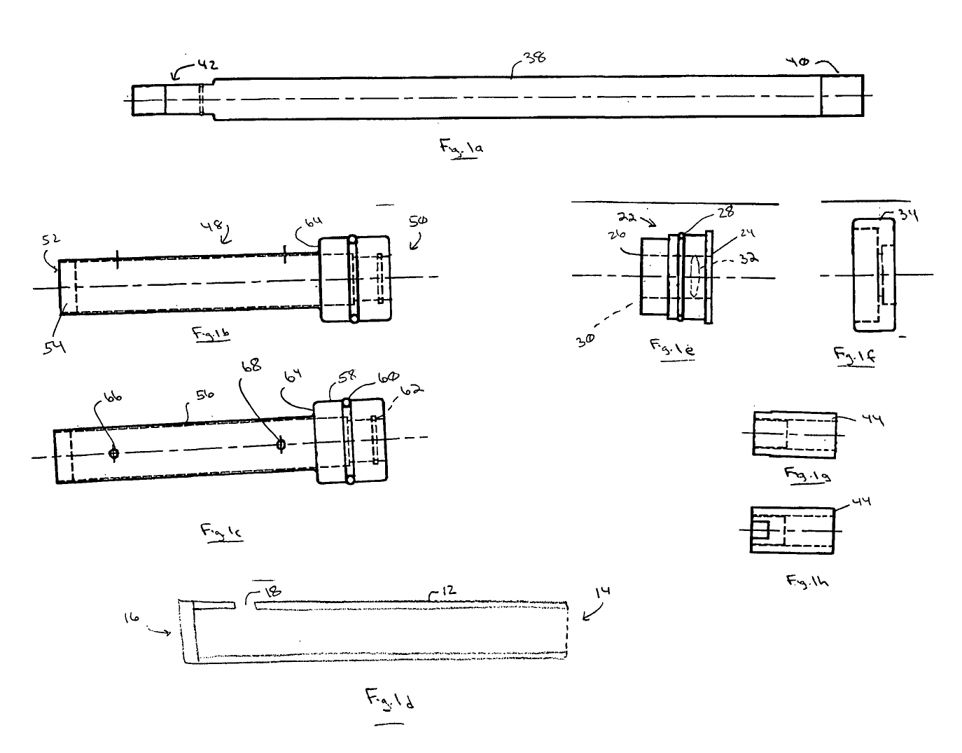

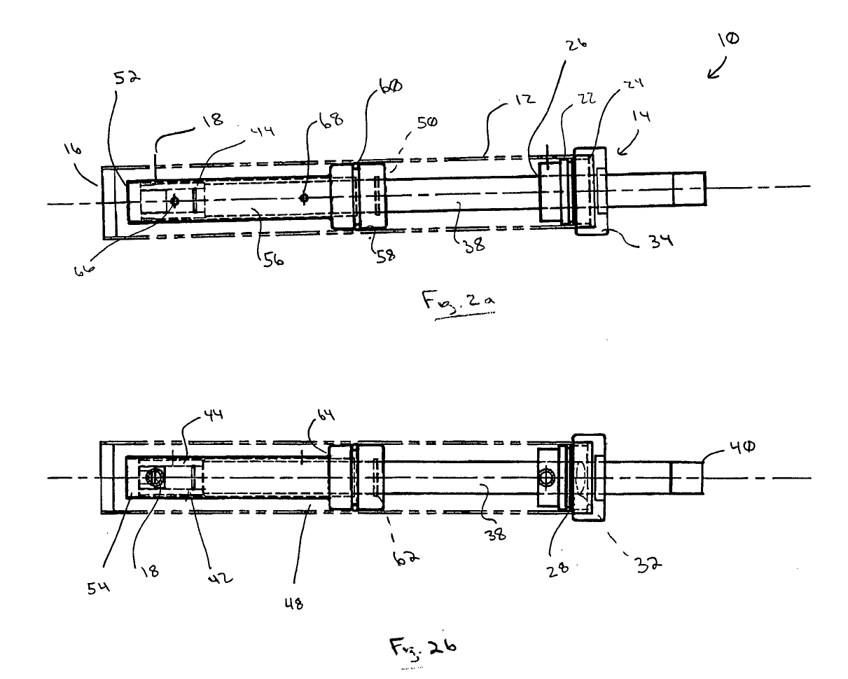

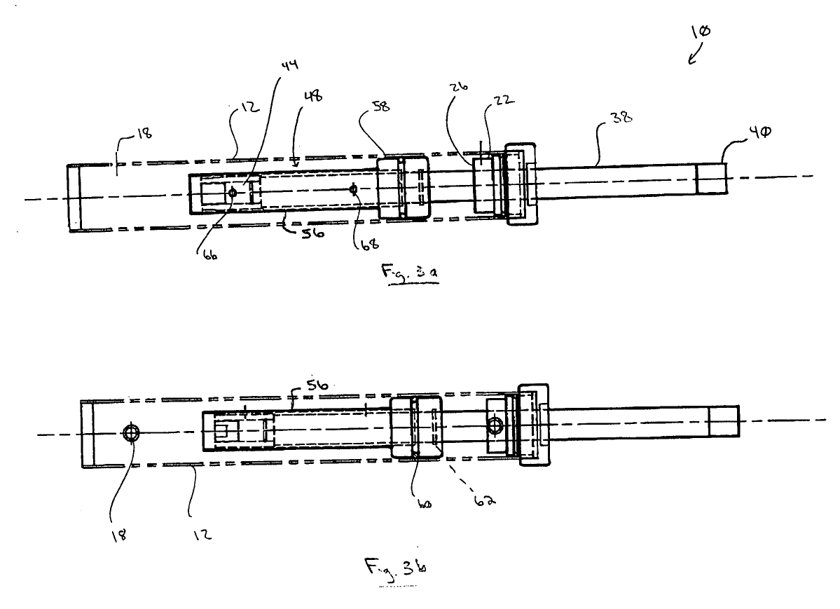

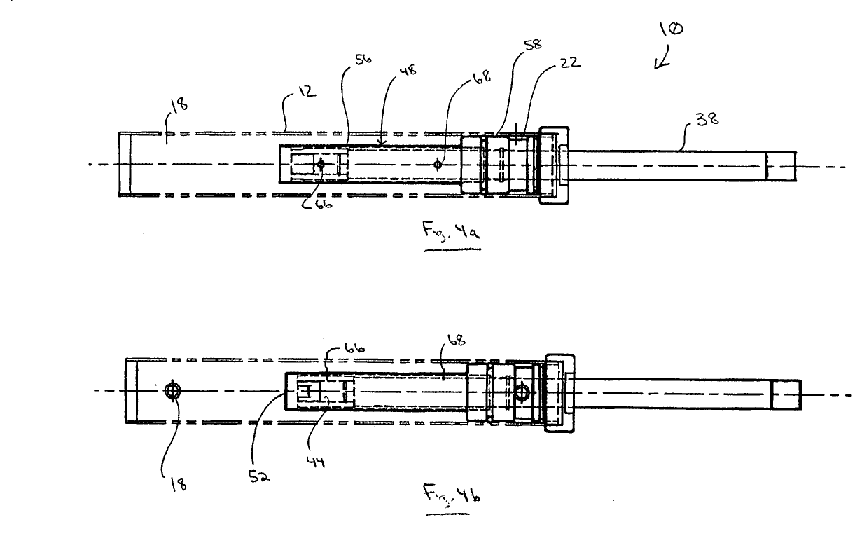

As shown in FIGS. 1a-h and 2a-b, a cylinder 10 of the invention includes an outer casing or tube 12 having a first end (open end) 14 and a second end (closed end) 16. The closed end 16 can be unitary with the rest of the tube 12 or can be closed by a removable cap, such as a conventional screw-type end cap. A cylinder port 18 is formed on the tube 12, for example, adjacent the closed end 16 of the tube 12. Thus, the tube 12 defines a hollow interior into which fluid can be introduced via the cylinder port 18. As will be appreciated by one skilled in the art, the tube 12 can be of any desired material, such as but not limited to metal or any other materials commonly used in the art.

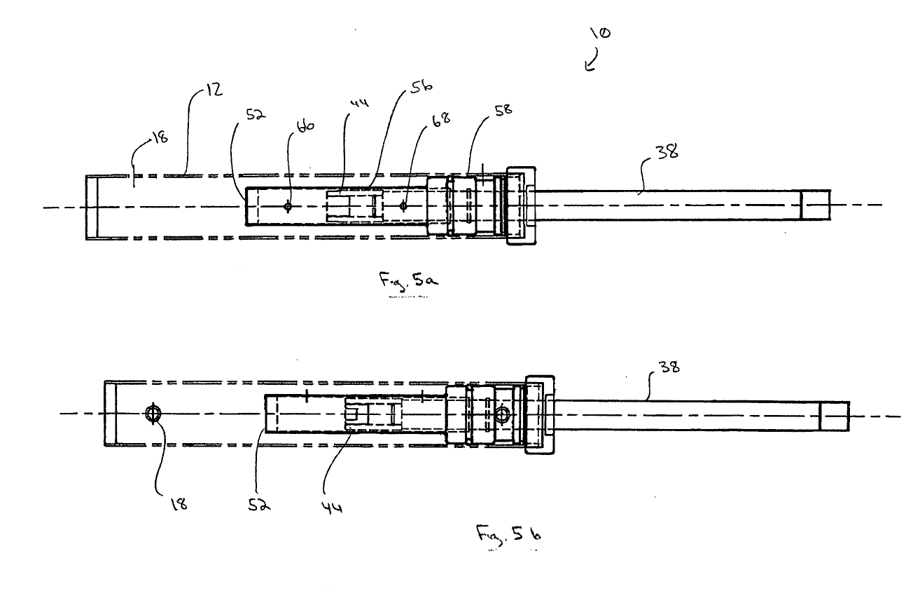

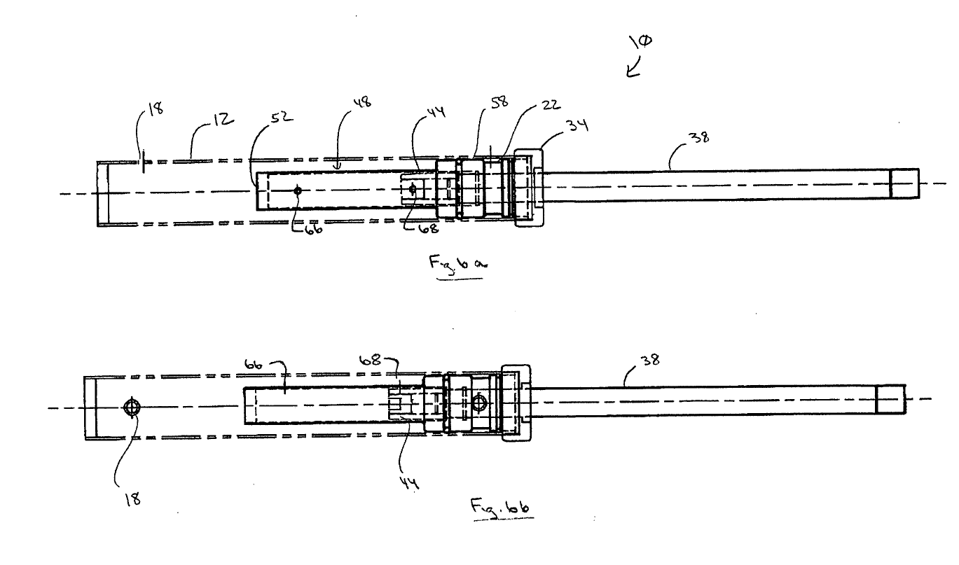

The cylinder 10 further includes a cylinder gland 22. The cylinder gland 22 can be positioned at or near the open end 14 of the tube 12, as shown in FIGS. 2a-b. The cylinder gland 22 has an outer end 24 and an inner end 26. The cylinder gland 22 has a seal 28 configured to seal against the inside of the tube 12. Additionally, the cylinder gland 22 includes a central passage 30 having a rod seal 32 configured to seal against the outside diameter of a rod, as will be explained in more detail below. The cylinder 10 of the invention can include a conventional gland cap 34 configured to retain the cylinder gland 22 inside the tube 12. For example, the gland cap 34 can have threads that can engage other threads on the first end 14 of the tube 12.

The cylinder 10 further includes a rod 38 having a first end 40 and a second end 42. The rod 38 can be of any desired material, such as but not limited to metal. In the illustrated embodiment, the rod 38 has a first diameter for the majority of its length and a second, smaller diameter at or near the second end 42. A rod bearing 44 can be connected to the second end 42 of the rod 38. The rod bearing 44 can have a larger diameter than the first diameter of the rod 38 to prevent the rod from being pushed out of the tube 12, as will be explained in more detail below.

To this point, the components of the cylinder 10 of the invention will be well understood by one of ordinary skill in the art. However, in the practice of the invention, the cylinder 10 also includes a bearing sleeve 48 of the invention (FIGS. 1b and 1c). The bearing sleeve 48 has an open end 50, a closed end 52, and a hollow interior. In one non-limiting embodiment, the closed end 52 can be closed by a removable sleeve cap 54. Alternatively, the closed end 52 of the bearing sleeve 48 can be permanently closed. The bearing sleeve 48 includes a hollow body portion 56 of a first diameter and a head portion 58 of a second, greater diameter. The head portion 58 includes a cylinder seal 60 configured to seal the bearing sleeve 48 against the inner diameter of the tube 12 to prevent fluid flow past the cylinder seal 60. The head portion 58 also includes a rod seal 62 configured to seal against the rod 38, as will be described in more detail below. The body 56 and head 58 define an annular lip 64 at the rear of the head 58. The bearing sleeve 48 also includes one or more sleeve ports. The illustrated bearing sleeve 48 has two spaced sleeve ports, e.g., a first or acceleration port 66 and a second or deceleration port 68.

Operation of the illustrated cylinder 10 will now be described.

An assembled cylinder 10 in accordance with the invention is shown in FIGS. 2a and 2b. FIGS. 2a and 2b illustrate the cylinder 10 in the fully retracted position, that is, with the rod 38 fully retracted into the tube 12. As can be seen, the first end 40 of the rod 38 extends out of the first end 14 of the tube 12 and is slidably supported by the cylinder gland 22. The second end 42 of the rod 38 with the rod bearing 44 attached extends into the hollow body 56 of the bearing sleeve 48. Thus, the rod 38 is slidably engaged with the rod seal 32 of the cylinder gland 22 and the rod seal 62 of the bearing sleeve 48.

When the rod 38 is to be extended, fluid, for example liquid or gas, is directed through the cylinder port 18 into the interior of the tube 12 between the tube end 16 and the head portion 58 of the bearing sleeve 48 around the bearing sleeve body 56. As will be appreciated from FIGS. 2a-b and 3a-b, as the fluid enters the tube 12, the fluid pressure against the inner surface of the bearing sleeve head 58 (i.e., against the annular lip 64) and the rear end of the sleeve body 56 pushes the bearing sleeve 48 to the right inside the tube 12. This carries the rod 38 to the right also. Some of the fluid in the interior of the tube 12 also enters into the body 56 of the bearing sleeve 48 through the first and second sleeve ports 66, 68. This is the beginning of the stroke that most resembles that of a conventional piston cylinder. That is, the increased area (lip 64) of the sleeve head 58 and the rear of the sleeve body 56 act like a piston surface and move the bearing sleeve 48 (carrying the rod 38) at a relatively high force but relatively low speed to the right.

As shown in FIGS. 4a and 4b, this “force stroke” continues until the front end 50 of the bearing sleeve 48 engages the inner end 26 of the cylinder gland 22. This contact prevents any further movement of the bearing sleeve 48 to the right. At this position, fluid fully fills the tube 12 between the rear surface (lip 64) of the sleeve head 58 and the tube end 16. As additional fluid is pumped into the tube 12 via the cylinder port 18, the fluid enters the sleeve body 56 through the sleeve ports 66 and 68 and begins to exert a force on the second end 42 of the rod 38 (that is, on the end of the rod bearing 44) to begin pushing the rod 38 out of the bearing sleeve 48 and, thus, farther out of the tube 12. The small gap between the outside of the rod bearing 44 and the inside of the sleeve body 56 provides a smooth acceleration of the rod 38 as it extends further out of the tube 12. When the inner end of the rod 38 (i.e., the end of the rod bearing 44) moves past the acceleration port 66, the rod acceleration will increase since the fluid no longer has to flow between the small gap between the rod bearing 44 and the inside of the tube 12. This is the beginning of the “high speed” stroke which simulates the action of a conventional rod cylinder. That is, at this time, the rod extension speed increases but the force of the rod decreases.

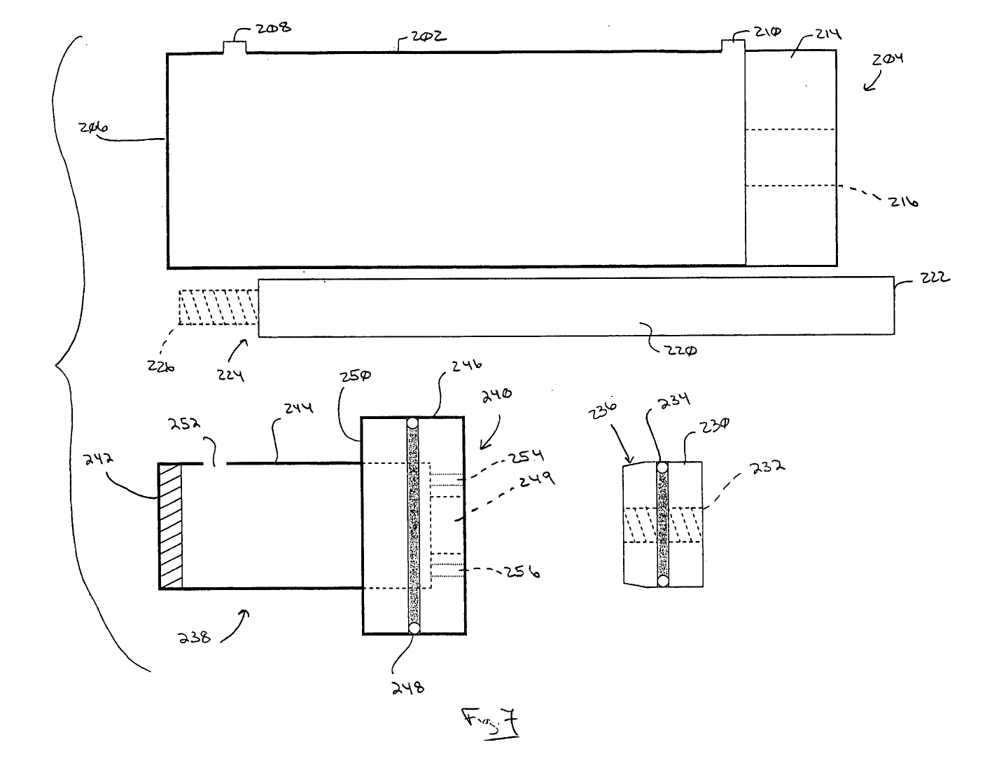

As shown in FIGS. 5a and 5b, the rod 38 continues to move out of the tube 12 (i.e., out of the bearing sleeve 48) as more fluid enters the sleeve ports 66 and 68. However, as the rod bearing 44 is pushed adjacent to the deceleration port 68 of the sleeve body 56, fluid becomes trapped between the rod bearing 44 and the sleeve head 58, causing the speed of the rod 38 to decrease as fluid is slowly squeezed out between the outside of the rod bearing 44 and the inside of the sleeve body 56.

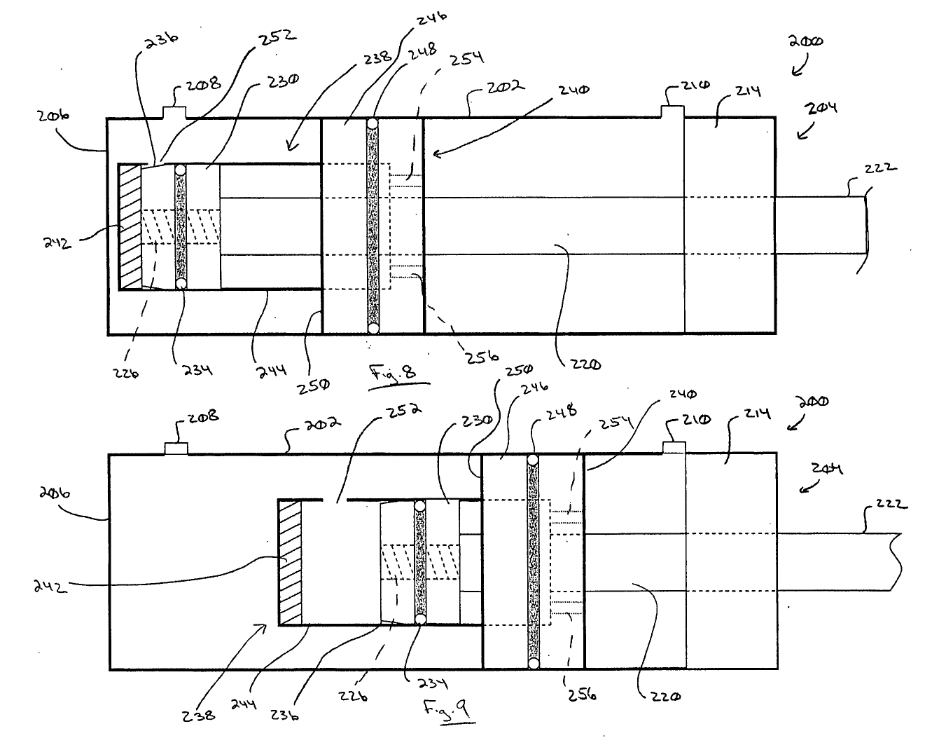

As shown in FIGS. 6a and 6b, when the rod 38 is fully extended, the front end of the rod bearing 44 contacts an annular retaining surface in the bearing sleeve 48 to prevent the rod 38 from extending any farther out of the tube 12.

The rod 38 can be retracted by allowing the fluid inside the tube 12 to flow out of the cylinder port 18 to permit the rod 38 and bearing sleeve 48 to move to the left, back to the fully retracted position shown in FIGS. 2a-b.

While the above describes one embodiment of the invention, it is to be understood that the invention is not limited to this particular embodiment. For example, an additional cylinder port can be provided at or near the open end 14 of the tube 12 to provide a double-acting cylinder. That is, when the rod 38 is to be retracted, fluid can be pumped into the cylinder port at the front of the tube 12 to push against the outer face of the sleeve head 58 and cause the bearing sleeve 48 to move to the left.

In another non-limiting embodiment, rather than having the acceleration and deceleration ports 66 and 68 as described above, the bearing sleeve 48 could have a single port to allow fluid to flow from the inside of the tube 12 into the interior of the bearing sleeve 48 so as to act upon the rod 38. For example, this single port could be located on the closed end 52 of the bearing sleeve 48 or anywhere on the sleeve body 56.

A double-acting cylinder 200 of the invention is shown in FIGS. 7-9. The cylinder 200 includes a tube 202 having a first end (open end) 204 and a second end (closed end) 206. As discussed above, the closed end 206 can be unitary with the rest of the tube 202 or can be closed by a removable cap, such as a conventional screw-type end cap. The tube 202 includes at least one extension port 208 and at least one retraction port 210. Thus, the tube 202 defines a hollow interior into which fluid can either be introduced or removed via the extension port 208 and/or retraction port 210. As will be appreciated by one skilled in the art, the tube 202 can be of any desired material, such as but not limited to metal or any other materials commonly used in the cylinder art.

The cylinder 200 further includes a cylinder gland 214. The cylinder gland 214 can be positioned at or near the open end 204 of the tube 202. The cylinder gland 214 includes a central passage 216 which can have a rod seal (not shown) configured to seal against the outside diameter of a rod, as described above. The cylinder gland 214 can also include a cylinder seal (not shown) configured to seal against the inside of the tube 202, in similar manner as described above.

The cylinder 200 further includes a rod 220 having a first end (outer end) 222 and a second end (inner end) 224. The rod 220 can be of any desired material, such as but not limited to metal. In the illustrated embodiment, the rod 220 has a first diameter for the majority of its length and a second, smaller diameter at or near the second end 224. In the illustrated embodiment, the second end 224 includes a threaded extension 226.

The cylinder 200 further includes a rod bearing (rod piston) 230 configured to engage the rod 220. In the illustrated embodiment, the rod bearing 230 is annular in shape and has a threaded central passage 232 extending at least partly therethrough. The rod bearing 230 further includes a seal 234. In one non-limiting embodiment, the rod bearing 230 may include a chamfered or tapered end region 236.

The cylinder 200 further includes a bearing sleeve 238. The bearing sleeve 238 has an open end 240 and a closed end 242. In one non-limiting embodiment, the closed end 242 can be closed by a removable sleeve cap (not shown). Alternatively, the closed end 242 can be permanently closed. The bearing sleeve 238 includes a hollow body portion 244 of a first diameter and a head portion 246 of a second, greater diameter. The head portion 246 includes a cylinder seal 248 configured to seal the bearing sleeve 238 against the inner diameter of the tube 202 to prevent fluid flow past the cylinder seal 248. The head portion 246 also includes a rod passage 249. The body 244 and head 246 define an annular lip 250 at the rear of the head 246. The bearing sleeve 238 also includes at least one sleeve port 252 providing fluid access into and out of the interior of the bearing sleeve 238. Additionally, the bearing sleeve 238 also includes one or more retraction channels. In the illustrated embodiment, the bearing sleeve 238 includes a first retraction channel 254 and a second retraction channel 256 extending through the head portion 246. The retraction channels 254 and 256 provide fluid communication between the interior of the bearing sleeve 238 and the exterior thereof. It is to be understood that the sleeve port(s) 252 and/or retraction channel(s) 254, 256 are not limited to the positions shown in the attached exemplary drawings but could be located anywhere on the bearing sleeve 238 to achieve the results described below. For example, the retraction channel could simply be a gap between the rod 220 and the inner diameter of the rod passage 249 or any similar arrangement.

FIG. 8 shows the components described above in a first assembled (retracted) position. As can be seen from FIG. 8, the bearing sleeve 238 is slidably positioned inside the tube 202, with the cylinder seal 248 slidably engaging the inner diameter of the tube 202. The rod 220 extends through the cylinder gland 214 and the rod passage 249 of the bearing sleeve 238. The second end 224 of the rod 220 engages the rod bearing 230. In the illustrated embodiment, the threaded extension 226 threadably engages the central passage 232 of the rod bearing 230. However, it is to be understood that this is simply one exemplary configuration. As will be appreciated by one of ordinary skill in the art, the rod bearing 230 could be attached to or formed on the rod 220 in any conventional manner, such as but not limited to welding or screws. Additionally, the rod bearing 230 could be a unitary portion of the second end 224 of the rod 220. That is, the rod bearing 230 could simply be a larger surface area portion at the second end 224 of the rod 220. Alternatively, no rod bearing 230 could be present

Operation of the cylinder 200 will now be described.

FIG. 8 illustrates the cylinder 200 in the fully retracted position, that is, with the rod 220 fully retracted into the tube 202. The first end 222 of the rod 220 extends out of the first end 204 of the tube 202 and is slidably supported by the cylinder gland 214. The second end 224 of the rod 220 with the rod bearing 230 attached extends into the hollow body 244 of the bearing sleeve 238.

When the rod 220 is to be extended, fluid, for example liquid or gas, is directed through the extension port 208 into the interior of the tube 202 between the closed end 206 of the tube 202 and the head portion 246 of the bearing sleeve 238. As the fluid enters the interior of the tube 202, the fluid pressure against the inner surface of the bearing sleeve head 246 (i.e., against the annular lip 250) and the rear end of the sleeve body 244 pushes the bearing sleeve 238 to the right inside the tube 202. This carries the rod 220 to the right also. Some of the fluid in the interior of the tube 202 also enters into the bearing sleeve 238 through the sleeve port 252. This is the beginning of the stroke that most resembles that of a conventional piston cylinder. That is, the increased area (lip 250) of the sleeve head 246 and the rear of the sleeve body 244 act like a piston surface and move the rod 220 (carried by the bearing sleeve 238) at a relatively high force but relatively low speed out of the tube 202. This “force stroke” continues until the front end 240 of the bearing sleeve 238 engages the inner end of the cylinder gland 214. This contact prevents any further movement of the bearing sleeve 238 to the right. At this position, fluid fully fills the interior of the tube 202 between the rear surface (lip 250) of the sleeve head 246 and the closed end 206 of the tube 202. As additional fluid is pumped into the tube 202 via the extension port 208, the fluid enters the sleeve body 244 through the sleeve port 252. This fluid flows through the small gap formed between the rod bearing 230 and the inner diameter of the body 244 of the bearing sleeve 238. The fluid begins to exert a force on the end of the rod bearing 230 to begin to push the rod bearing 230 (and thus the rod 220) to the right and out of the bearing sleeve 238. The small gap formed between the rod bearing 230 and the inside of the sleeve body 244 provides a smooth acceleration of the rod 220 as it extends out of the tube 202. When the end of the rod bearing 230 moves past the sleeve port 252, the rod acceleration will increase since the fluid no longer has to flow through the small gap between the rod bearing 230 and the inside diameter of the body 244. This is the beginning of the “high speed” stroke, which simulates the action of a conventional rod cylinder. That is, at this time, the rod extension speed increases but the force of the rod decreases.

As shown in FIG. 9, the rod 220 continues to move to the right as fluid is pumped through the extension port 208 into the interior of the tube 202 and from there flows through the sleeve port 252 into the interior of the sleeve body 244. The rod bearing 230 continues to move to the right until it contacts the annular inner surface of the sleeve head 246. The rod 220 can be hydraulically locked in any desired position by closing the extension port 208 to cease fluid flow into the tube 202.

When the rod 220 is to be retracted, the extension port 208 can be opened to allow fluid to flow out of the interior of the tube 202 and allow the rod 220 to move to the left inside the tube 202, such as by the weight of the load. This is similar to the embodiment described above. However, in the embodiment illustrated in FIGS. 8 and 9, the rod 220 could also be retracted under fluid pressure. For example, to retract the rod 220, the extension port 208 can be opened to allow fluid flow out of the interior of the tube 202 and fluid can be injected into the interior of the tube 202 through the retraction port 210. As will be appreciated from FIGS. 8 and 9, as fluid enters the retraction port 210, the fluid pushes against the front end 240 of the bearing sleeve 238, which pushes the bearing sleeve 238 to the left and begins pushing the rod 220 back into the interior of the tube 202. This movement can continue until the second end 242 of the bearing sleeve 238 is at or adjacent the second end 206 of the tube 202 and fluid fills the interior of the tube 202 between the front end 240 of the bearing sleeve head 246 and the rear end of the cylinder gland 214.

As more fluid is pumped into the interior of the tube 202 through the retraction port 210, this fluid flows through the retraction channels 254 and 256 into the interior of the bearing sleeve 238. As can be appreciated from FIG. 9, as the fluid flows through the retraction channels 254 and 256, the fluid exerts pressure on the front end of the rod bearing 230 and pushes the rod bearing 230 to the left. As the rod bearing 230 moves to the left, the rod bearing 230 pushes fluid out of the interior of the sleeve body 244, through the sleeve port 252, and into the interior of the tube 202 where it can flow out of the extension port 208. This movement of the rod bearing 230 can continue until the rod bearing 230 is at or adjacent the second end 242 of the sleeve body 244, thus retracting the rod 220 fully into the tube 202.

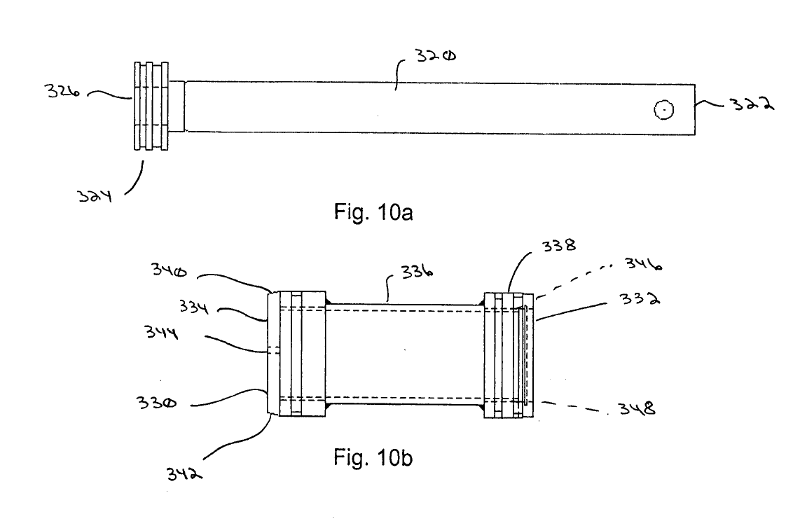

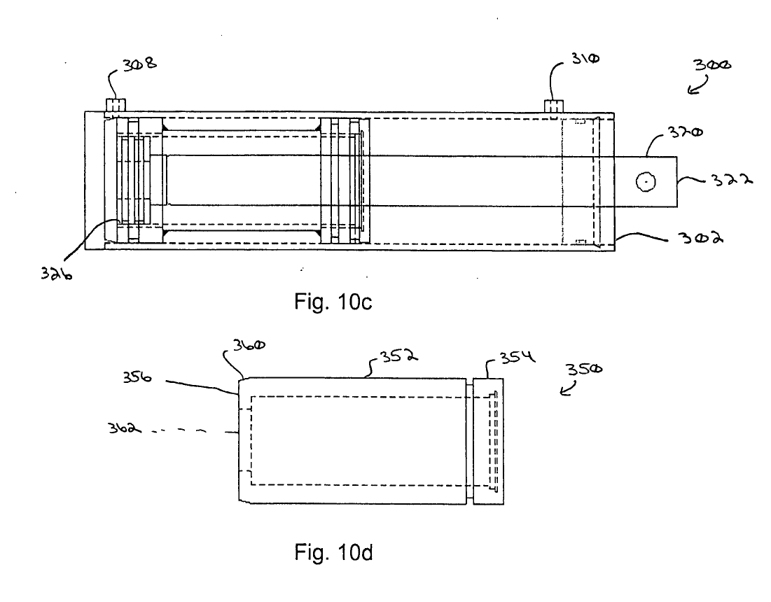

Another cylinder 300 is shown in FIGS. 10a-10c. The cylinder 300 includes a tube 302 (similar to 202 described above). The tube 302 includes at least one extension port 308 and at least one retraction port 310. The cylinder 300 further includes a rod 320 having a first end (outer end) 322 and a second end (inner end) 324. The rod 320 has a piston head 326 (rod bearing) attached to the inner end 324 of the rod 320.

The cylinder 300 further includes a bearing sleeve 330 having a first end 332 and a second end 334. The rod 320 slides through a bore in the first end 332 of the bearing sleeve 330. The bearing sleeve 330 has a hollow body portion 336 with a first head portion 338 adjacent the first end 332 and a second head portion 340 adjacent the second end 334. The first and/or second head portions 338, 340 can include wear bands or other conventional sealing devices to seal the bearing sleeve 330 against the inner diameter of the tube 302. The second head portion 340 has a tapered end region 342 to allow fluid to flow behind the bearing sleeve 330, as will be described in more detail below. The bearing sleeve 330 also includes at least one sleeve port 344 providing fluid access into and out of the interior of the bearing sleeve 330. In the illustrated embodiment, the sleeve port 344 is formed through the second end (end wall) of the bearing sleeve 330. Additionally, the bearing sleeve 330 includes one or more retraction channels. In the illustrated embodiment, the bearing sleeve 330 includes a first retraction channel 346 and a second retraction channel 348 extending through the first head portion 338. The retraction channels 346 and 348 provide fluid communication between the interior of the bearing sleeve 330 and the interior of the tube 302.

FIG. 10c shows the components described above in a first assembled (retracted) position. Operation of the cylinder 300 is similar to that described above for the cylinder 200 except that the fluid enters the bearing sleeve 330 through the sleeve port 344 on the end of the bearing sleeve 330, rather than a sleeve port on the side of the bearing sleeve 330.

An alternative bearing sleeve 350 is shown in FIG. 10d. This bearing sleeve 350 has a body 352 of substantially uniform diameter having a first end 354 and a second end 356. A seal or gasket can be provided at or near the first end 354. The second end 356 can include a tapered end region 360. The bearing sleeve 350 includes a sleeve port or fluid inlet 362 formed in the second end 356 of the bearing sleeve 350. The bearing sleeve 350 is of a simpler design than of the bearing sleeve 330 and, thus, should be less expensive to manufacture.

In addition to providing a cylinder of the invention as described in any of the embodiments above, the present invention also includes the concept of converting or retrofitting a conventional cylinder to be a two-speed cylinder incorporating features of the invention. For example, a conventional cylinder having an outer tube and a piston slidably moveable within the tube can be converted to a two-speed cylinder of the invention by incorporating a bearing sleeve of the invention into the tube. For example, the original rod can be utilized or the rod can be modified to attach a piston head to the inner end of the rod, if desired. The conventional cylinder can be modified by adding a bearing sleeve, such as any of the bearing sleeves described above, into the conventional cylinder tube.

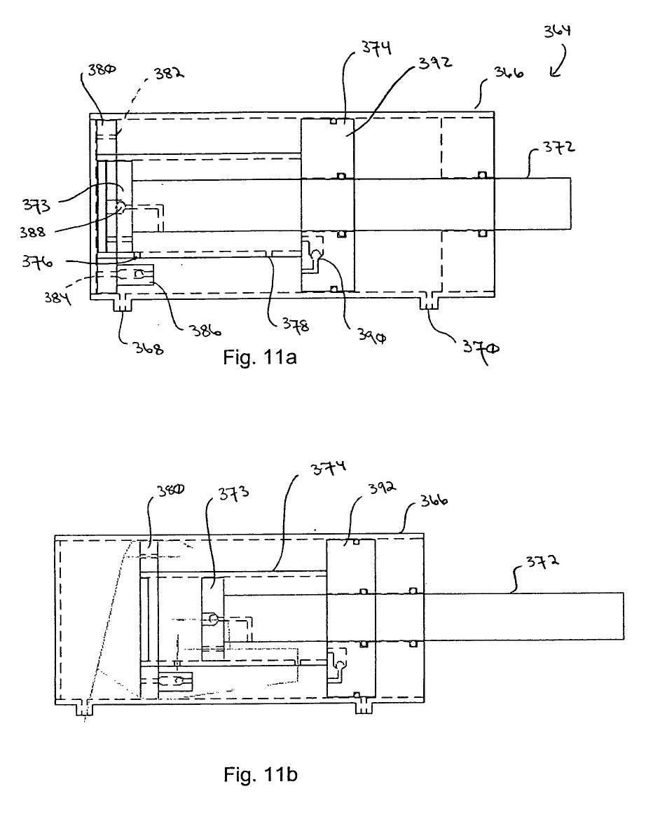

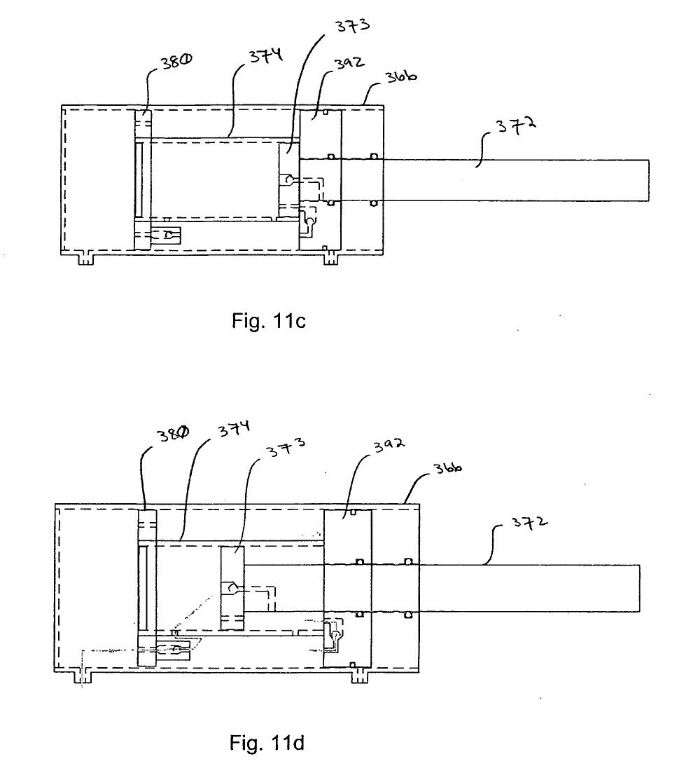

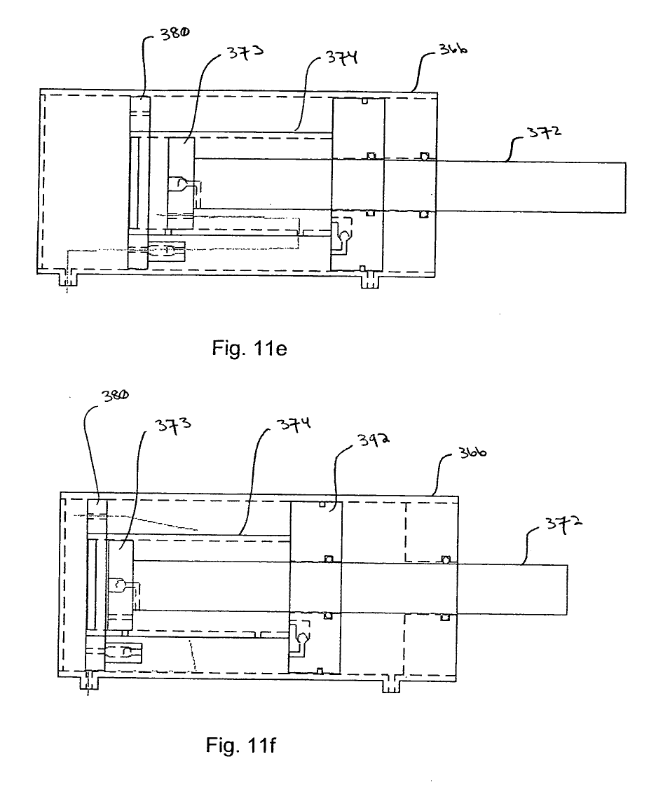

Another cylinder 364 of the invention is shown in FIGS. 11a-11f. Cylinder 364 includes a tube 366 that can include an extension port 368 and a breather port 370. A rod 372 is moveably mounted in a bearing sleeve 374 in a similar manner as the cylinder of 300 described above. However, in this embodiment, the bearing sleeve 374 includes a sleeve extension port 376 and a sleeve retraction port 378 formed on the sidewall of the bearing sleeve 374. The bearing sleeve 374 also includes a piston sleeve bearing 380 having a first piston sleeve orifice 382 and a second piston sleeve orifice 384. However, unlike the previous embodiments, the cylinder 364 includes a check valve assembly which, in the illustrated embodiment, has a first check valve 386 in fluid communication with the second piston sleeve orifice 384. A second check valve 388 is located on a piston rod bearing 373 and is in fluid communication with a channel extending through the piston rod 372. A third check valve 390 is located on a bearing sleeve head 392. The check valve assembly prevents vacuum locks during retraction of the rod 372.

Operation of the cylinder 364 will now be described with particular reference to FIGS. 11a-f. FIG. 11a shows the cylinder 364 in the retracted position. That is, the rod 372 and bearing sleeve 374 are to the left of the cylinder 364. To extend the rod 372, fluid is introduced through the extension port 368, which causes the bearing sleeve 374 to begin moving to the right. Eventually, the bearing sleeve 374 will reach the right-most position, as shown in FIG. 11b. As fluid continues to enter the extension port 368, the fluid is directed through the piston sleeve orifice and into the interior of the bearing sleeve 374 to move the rod bearing 373 to the right. The rod 372 continues to move to the right until it reaches the fully extended position shown in FIG. 11c. The rod 372 can be held in this extended position by fluid lock. When it is desired to retract the rod 372, the fluid lock is removed and the weight on the outer end of the rod 372 causes the rod 372 to move to the left, as shown in FIG. 11d. During this retraction, fluid on the inside of the bearing sleeve 374 flows out of the sleeve extension port 376, through the first check valve 386, and out the extension port 368. In the event that the rate of fluid flow causes a vacuum to develop in the region of the bearing sleeve 374 in front of the rod bearing 373, the third check valve 390 allows fluid flow from the area between the outside diameter of the bearing sleeve 374 and the inside diameter of the tube 366 to flow into this region to prevent a vacuum lock and provide for smooth operation of the cylinder 364. As shown in FIG. 11d, eventually the rod bearing 373 will move to close off the sleeve extension port 376. At this point, fluid flows through the rod bearing orifice and out of the sleeve retraction port 378, through the first check valve 386, and out the extension port 368 to provide a cushioning effect for the rod 372 to move completely to the left (retracted) position.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A cylinder, comprising:
a cylinder tube having a first end and a second end, with at least one cylinder port located in the tube;
a bearing sleeve movably mounted in the tube, the bearing sleeve comprising a body having at least one port, and a bearing sleeve head; and
a rod having a first end and a second end, with the second end of the rod configured to slidably engage the bearing sleeve.

2. The cylinder according to claim 1, wherein the cylinder tube comprises an extension port spaced from a retraction port.

3. The cylinder according to claim 1, wherein the bearing sleeve comprises a sleeve extension port and a sleeve retraction port.

4. The cylinder according to claim 1, wherein the at least one bearing sleeve retraction port is located on a sidewall of the bearing sleeve.

5. The cylinder according to claim 1, wherein the at least one bearing sleeve port is located on an end wall of the bearing sleeve.

6. The cylinder according to claim 1, wherein the bearing sleeve head includes at least one retraction channel.

7. A cylinder according to claim 1, wherein the bearing sleeve body has a first diameter and the bearing sleeve head has a second diameter greater than the first diameter.

8. The cylinder according to claim 1, wherein the rod includes a rod bearing slidably moveable in the bearing sleeve.

9. The cylinder according to claim 8, wherein the rod bearing has a tapered end region.

10. The cylinder according to claim 1, wherein the cylinder includes a check valve assembly.

11. The cylinder according to claim 10, wherein the bearing sleeve includes a sleeve extension port and a sleeve retraction port, with a first check valve connected to the sleeve extension port.

12. The cylinder according to claim 10, wherein the cylinder includes a second check valve connected to a rod bearing.

13. The cylinder according to claim 10, wherein the cylinder includes a third check valve connected to the bearing sleeve head.

14. A cylinder, comprising:
a cylinder tube having at least one cylinder port;
a bearing sleeve movably carried on the cylinder tube, the bearing sleeve comprising a body portion and at least one sleeve port; and
a rod having a first end and a second end, with the second end of the rod movably carried in the bearing sleeve.

15. The cylinder according to claim 14, wherein the bearing sleeve includes a tapered end region.

16. The cylinder according to claim 14, wherein the bearing sleeve includes a first head portion spaced from a second head portion, and wherein the second head portion includes a tapered end region.

17. The cylinder according to claim 14, wherein the bearing sleeve includes at least one retraction port.

18. The cylinder according to claim 14, wherein the rod includes a piston head carried on the second end of the rod.
